(19) United States
(12) Patent Application Publication
(10) Pub. No.: US 2007/0172344 A1
(43) Pub. Date: Jul. 26, 2007

(54) Device for transporting work pieces through pressing systems

(75) Inventor: Rainer Reichenbach, Schlier (DE)

Correspondence Address: JORDAN AND HAMBURG LLP, 122 EAST 42ND STREET, SUITE 4000, NEW YORK, NY, 10168, US

(73) Assignee: MUELLER WEINGARTEN AG, WEINGARTEN (DE)

(21) Appl. No.: 10/588,663

(22) PCT Filed: Feb. 4, 2005
(86) PCT No.: PCT/DE05/00188

§ 371 Date: Aug. 7, 2006

(30) Foreign Application Priority Data
Feb. 7, 2004 (DE) 10 2004 006 085.1

(51) Int. Cl. B65G 1/133

(52) U.S. Cl. 414/751.1

(57) ABSTRACT

The invention relates to a device for transporting work pieces through pressing systems, in particular a double hinged arm feeder for step presses or press working lines. Said transport device is configured in such a manner that the work pieces are transported at high speed with a large system rigidity. The hinged arm is pivotably mounted on a slit which supports the pivot drive and which is guided on a rail whereon at least one stationary drive is located enabling the slits to move in a horizontal manner in relation to the slits and the whole unit can be moved in a vertical manner over at least one stationary lift drive. Due to said configuration, the hinged arm or the two hinged arm parts only have a small looped length.

### BACKGROUND OF THE INVENTION

The invention relates to a device for transporting workpieces through work stations of a press or press line.

Where the manufacture of a workpiece calls for a plurality of processing steps, such as punch and shaping operations, then for economic production the necessary individual operations are carried out in a transfer press or press line.

As a rule, such systems are provided with conveying devices for automatically conveying workpieces. DE 195 21 976 A1 suggests various such conveying devices. A so-called articulated arm feeder is also disclosed in this document. The entire drive system is arranged above the workpiece conveying plane in a particularly advantageous manner. This structural design enables optimum accessibility for the press area.

It is also possible to retrofit the articulated arm feeder on available large-component transfer presses or press lines without great difficulty. The articulated arm feeder can be used without limitation both in mechanically driven and hydraulically driven presses.

In principle, the articulated arm feeder comprises two articulation components that form the articulated arm. The articulated arm is driven such that a pivot movement in the horizontal plane can be performed about a vertical axis. Further degrees of freedom are provided, such as e.g. horizontal travelability in and counter to the workpiece conveying direction. A vertical lift device is also integrated into the part of the articulated arm feeder that can travel. The actual holding means for the workpiece are attached to transverse crossmembers, the so-called suction bars.

Furthermore known from this document is that the articulated arm feeder can be embodied with two articulated arms that are arranged mirroring one another as a so-called dual articulated arm feeder.

These embodiments have in common the problem that the free projecting articulation components of the articulated arm tend to experience undesired severe vibrations at high dynamic stress.

The underlying object of the invention is to prevent the aforesaid disadvantage and to improve the stiffness of the articulated arm feeder such that secure workpiece conveyance is assured at high dynamics.

### SUMMARY OF THE INVENTION

The idea underlying the invention is to design the articulated arm feeder such that the articulated arm or the two articulation components must project only slightly. In addition, the moved mass is substantially reduced and thus the dynamics of the articulated arm feeder are improved.

This is achieved in that a carriage carrying the articulated arm travels close to the press or shaping station. For this purpose, the carriage itself is provided with only a horizontal drive. The carriage is guided and borne on a crossmember that itself is connected to a vertical axis of movement. The desired low-mass design is possible because of this separation of the axes of movement. The large horizontal conveyance path is thus embodied by the carriage that is burdened with a low mass and by the articulated arm, which enables rapid acceleration and speed. The significantly smaller vertical lift is then performed including the crossmember.

The use of two articulated arms, as a dual articulated arm feeder, additionally attains an increase in stiffness and thus reduces the vibrations. The transverse crossmember, located on the front end of the articulated arms, with the workpiece holding means is supported much better by the dual articulated arm feeder.

In particular, the vertically and horizontally occurring torque and tilt moment are supported or partially compensated. The acceleration forces from horizontal acceleration when the workpiece is conveyed are also absorbed in a favorable manner by the closed articulated arrangement.

As an additional advantage, in dual articulated arm feeders, the structural height of the articulated arms can be reduced, which, in addition to the low mass, improves the clearance to the punch when the workpiece is mounted or removed.

The articulated arm feeder can be provided additional degrees of freedom with no problem and thus can perform all of the movements required for changing the position of the workpiece. Thus an intermediate or orientation station is not required as a rule. It is also possible to convey dual parts without limitation.

The joining of the articulated arm to the transverse crossmember with the workpiece holding means is configured such that very different systems can be coupled by means of an adapter.

Actuation of the workpiece holding means is provided via the two articulated arms at a low structural height with advantageous clearance. Non-rotatable rollers for the actuation chain are provided at the articulation point of rotation and on the transverse crossmember, while the levers have rotatably borne rollers that are moved through the actuation chain.

Additional details and advantages of the invention result from the description of and the figures for one exemplary embodiment.

### BRIEF DESCRIPTION OF THE DRAWINGS

FIG. 1 is a schematic depiction of two presses in a press line with a conveying device;

FIG. 2 is a top view of FIG. 1;

FIG. 3 is an elevation of a press with a conveying device transverse to the direction of conveyance.

### DETAILED DESCRIPTION OF THE INVENTION

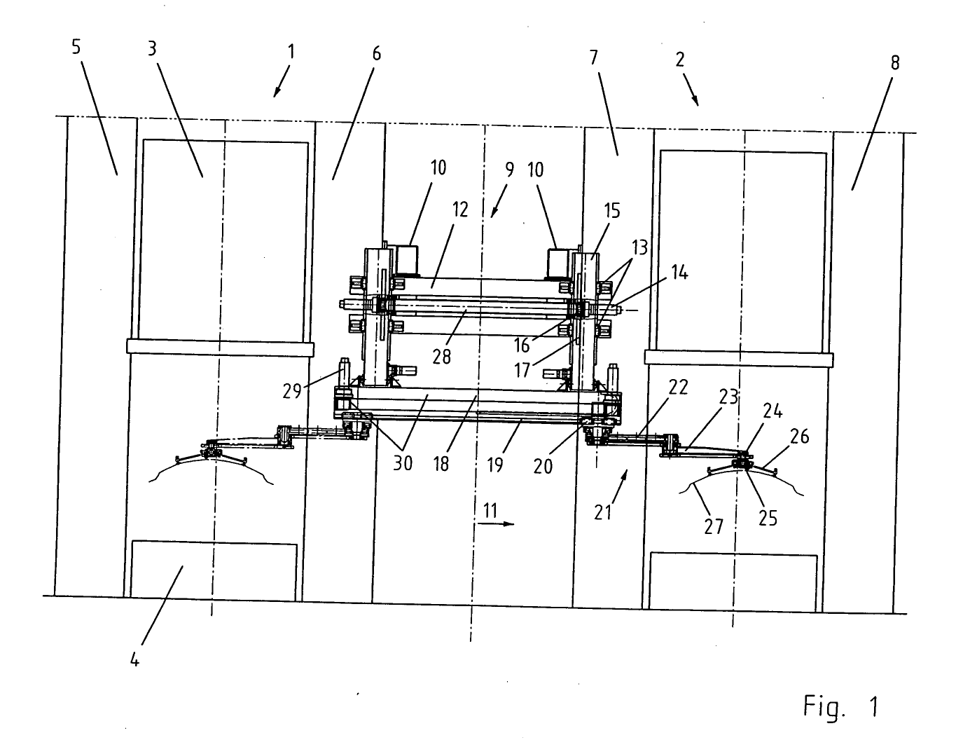

FIG. 1 depicts two presses 1, 2 in a press line. The ram 3, sliding table 4, and uprights 5-8 can be seen. The inventive conveying device 9 connects the presses 1 and 2. The conveying device 9 is held by two crossmembers 10 that are attached to the uprights 6, 7 transverse to the workpiece conveying direction 11. A mounting plate 12 is connected to the crossmembers 10 and carries the guide 13 and the lift drive 14 for the lift column 15. The lift movement is initiated via a toothed wheel 16 that is attached to the shaft of the lift drive 14 mechanically linked to a rack 17 that is disposed on the lift column 15. There can be two lift drives 14 that can be forcibly synchronized using a connecting tube 28. At the lower end of the lift column 15, a crossmember 18 is attached to the linear guide 19 for the carriage 20 of the articulated arm 21. The articulated arm 21 comprises a first articulation component 22 and a second articulation component 23 that have the same lift heights. At the outer end of the second articulation component 23 is an element 24 for the transverse crossmember 25 that carries the workpiece holding means 26 for the workpiece 27.

Provided for horizontal conveyance movements are the drives 29 that are mechanically linked to the toothed belt gear 30 to which the carriage 20 is attached. In this structural arrangement, it can be easily discerned that the articulated arm 21 requires only a slight projection. Likewise an optimum structural height and thus favorable clearance to the punch is attained.

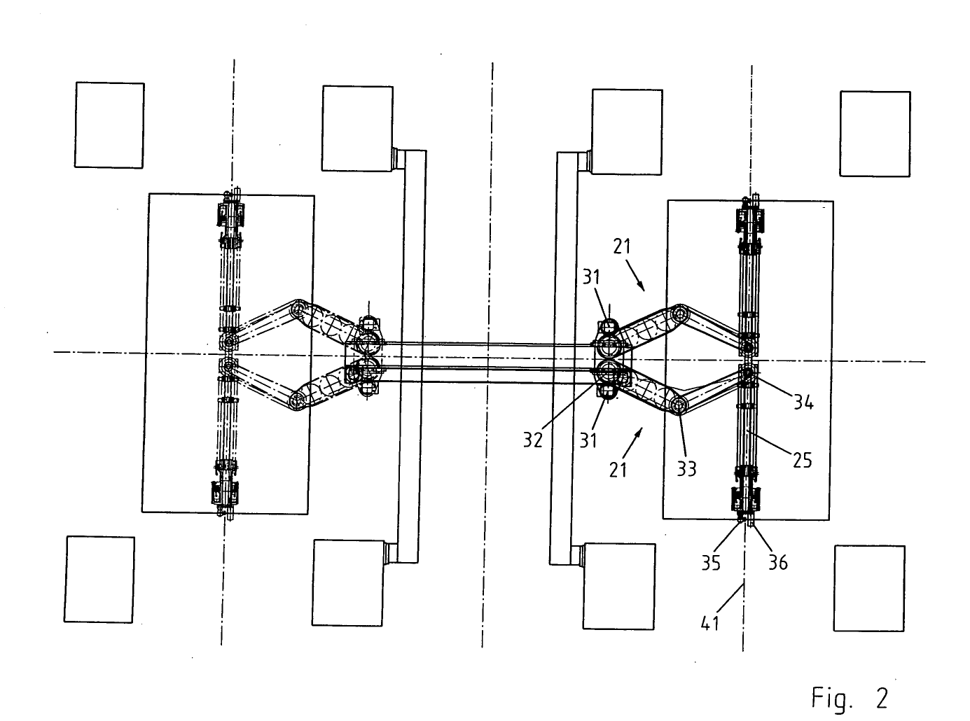

FIG. 2 illustrates the embodiment as a dual articulated arm. The articulated arms 21 are arranged in a mirror image to one another and are driven in opposition to one another. The drive motor of the respective pivot drives 31 acts via a gear step on the first pivot axis 32 and via a gear chain on the second pivot axis 33. The pivot axis 33 is joined to the pivot and bearing axis 34 via a toothed belt gear. The element 24 for the transverse crossmember 25 is attached to the pivot and bearing axis 34. The drives 35 enable additional degrees of freedom for rotating the transverse crossmembers 25 about their respective axis 41 and the drives 36 make it possible for the workpiece holding means 26 to travel transverse to the workpiece conveying direction 11. The structural design and sequence of movements are described in detail in DE 195 21 976 A1.

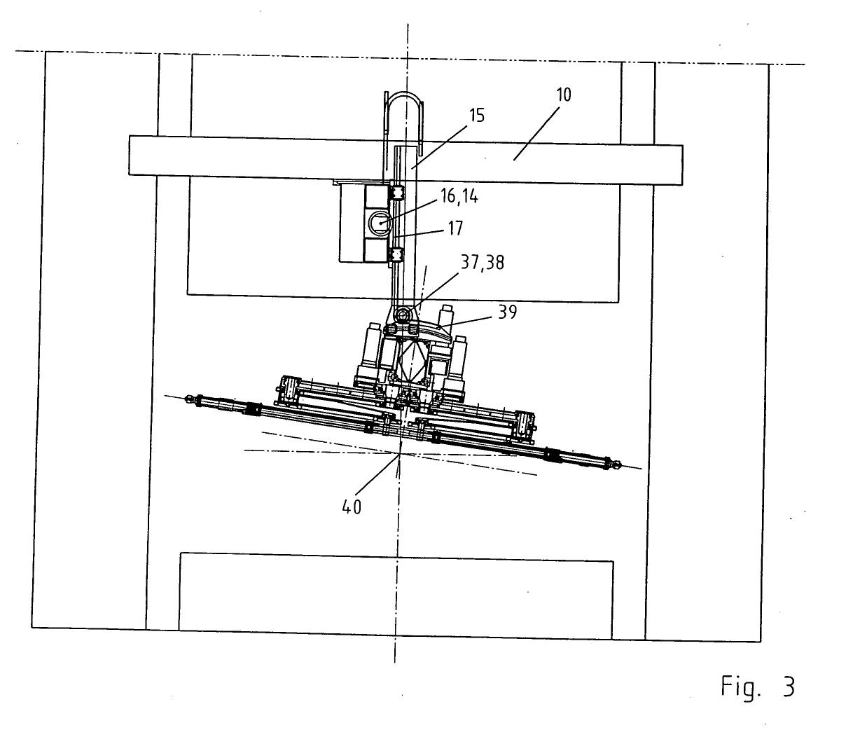

FIG. 3 depicts pivoting transverse to the workpiece conveying direction 11 as another degree of freedom. A drive 37 drives a toothed wheel 38 that is mechanically linked to a toothed segment 39 and pivots the workpiece 27 about the axis 40.

FIG. 3 also provides design details for vertical travelability. The fixed lift drive 14 drives a toothed wheel 16, this initiating the vertical movement of the lift column 15 via the rack 17.

The invention is not limited to the described and illustrated exemplary embodiment.

| | |
|---|---|
| 1 | Press |
| 2 | Press |
| 3 | Ram |
| 4 | Sliding table |
| 5 | Upright |
| 6 | Upright |
| 7 | Upright |
| 8 | Upright |
| 9 | Conveying device |
| 10 | Crossmember |
| 11 | Workpiece conveying direction |
| 12 | Mounting plate |
| 13 | Guide |
| 14 | Lift drive |
| 15 | Lift column |
| 16 | Toothed wheel |
| 17 | Rack |
| 18 | Crossmember |
| 19 | Linear guide |
| 20 | Carriage |
| 21 | Articulated arm |
| 22 | First articulation component |
| 23 | Second articulation component |
| 24 | Element |
| 25 | Transverse crossmember |
| 26 | Workpiece holding means |
| 27 | Workpiece |
| 28 | Connecting tube |
| 29 | Drive |
| 30 | Toothed belt gear |
| 31 | Pivot drive |
| 32 | Pivot axis |
| 33 | Pivot axis |
| 34 | Pivot and bearing axis |
| 35 | Drive |
| 36 | Drive |
| 37 | Drive |
| 38 | Toothed wheel |
| 39 | Toothed segment |
| 40 | Axis |
| 41 | Axis |

1-5. (canceled)

6. Transporting apparatus for transporting workpieces through processing stations at which the workpieces are processed, the transporting apparatus comprising at least one articulated arm supported above a plane in which the workpieces are transported for transporting each of said workpieces in a transporting direction from a processing station to a next processing station without the interposition of an intermediate station, the articulated arm being arranged for transporting each said workpiece with at least a lifting movement, a pivoting movement about an axis perpendicular to said plane and a horizontal movement parallel to said plane, each said articulated arm comprising first and second arm components connected together by an articulation, the transporting apparatus further comprising a longitudinal crossmember mounted above said plane and extending in the workpiece transporting direction, a carriage guided on the longitudinal crossmember, each said articulated arm being pivotably mounted on the carriage, a pivot drive mounted on the carriage for effecting said pivoting movement, a drive fixed relative to the carriage for effecting horizontal movement of the carriage and a lift drive for effecting said lift movement.

7. Apparatus according to claim 6, wherein said at least one articulated arm comprises two articulated arms for feeding respective workpieces to respective processing stations, the two articulated arms being arranged as mirror images each of the other, and wherein, for each said articulated arm, a respective said pivot drive is mounted on the carriage, each said pivot drive effecting said pivoting movement of each said articulated arm in opposition to the other.

8. Transporting apparatus according to claim 6, further comprising a transverse crossmember which is pivotable about an axis parallel to said plane and extending in the workpiece transporting direction, a drive for the pivoting of the transverse crossmember, a toothed wheel driven by the drive for the pivoting and a toothed member arranged to be engaged by the toothed wheel.

9. Transporting apparatus according to claim 6, wherein said transverse crossmember is rotatable about an axis extending through a lengthwise dimension of said transverse crossmember and the transporting apparatus further comprises a drive for rotating said transverse crossmember about said axis of said transverse crossmember.

10. Transporting apparatus according to claim 6, further comprising a workpiece holder mounted on each of said at least one articulated arms and a respective drive for each said workpiece holder for moving the workpiece holder in a direction transverse to the workpiece transporting direction.
